(19) United States
(12) Patent Application Publication
(10) Pub. No.: US 2026/0058480 A1
(43) Pub. Date: Feb. 26, 2026

(54) A SYSTEM FOR CHARGING CORDLESS POWER TOOL BATTERIES

(71) Applicant: HUSQVARNA AB, Huskvarna (SE)

(72) Inventors: Ruben ENRIQUEZ, Concord, NC (US); David England EIDSON, Charlotte, NC (US); Jack Coleman EASTERLY, III, Charlotte, NC (US); Daniel BOOTH, Charlotte, NC (US); Paul DILDINE, Rock Hill, SC (US); Paul WARFEL, Davidson, NC (US)

(21) Appl. No.: 19/105,790

(22) PCT Filed: Jul. 31, 2023
(86) PCT No.: PCT/SE2023/050762

§ 371 Date: Feb. 21, 2025

Related U.S. Application Data
(60) Provisional application No. 63/399,882, filed on Aug. 22, 2022.

(51) Int. Cl. H02J 7/00; H02J 7/02

(52) U.S. Cl. CPC H02J 7/0013; H02J 7/0044; H02J 7/0048; H02J 7/007; H02J 7/02; H02J 2207/20

(57) ABSTRACT

A system for charging a plurality of cordless power tool batteries includes charging circuitry and a plurality of docking stations. The charging circuitry includes a plurality of electrical connectors connectable to up to j>1 electrical loads, and primary control circuitry to direct DC output power to k≤j of the electrical connectors that are connected to k≤j electrical loads, separately and in succession. The plurality of docking stations are connectable to the plurality of electrical connectors as the k≤j electrical loads. Each docking station includes charging ports to receive up to m>1 of the cordless power tool batteries, and secondary control circuitry to direct the DC output power to recharge n≤m of the cordless power tool batteries that are received by the plurality of charging ports, separately and in succession under control of the primary control circuitry.

### TECHNOLOGICAL FIELD

The present disclosure relates generally to charging of rechargeable batteries and, in particular, to charging cordless power tool batteries.

### BACKGROUND

Property maintenance tasks are commonly performed using various tools and/or machines that are configured for the performance of corresponding specific tasks. Certain tasks, like cutting trees, trimming vegetation, blowing debris and the like, are typically performed by handheld tools or power equipment. The handheld power equipment may often be powered by gas or electric motors. Until the advent of battery-powered, cordless power tools, gas powered motors were often preferred by operators that desired, or required, a great deal of mobility. But as battery technology continues to improve, the robustness of battery-powered equipment has also improved and such devices have increased in popularity.

A number of commercial lawn, garden and landscaping operations employ cordless power tools, and these operations have a need to maintain a large number of batteries on a daily bases. The goal is to provide a solution that can recharge their batteries overnight at a facility where the alternating current (AC) power is readily available so they are ready for the next work day. Current solutions that use separate chargers to charge an array of batteries are inconvenient and inefficient as those solutions need multiple power outlets and even upgrades to legacy electrical systems to provide enough wall outlets to plug in multiple chargers, often as many as 20 to 30 chargers.

It would therefore be desirable to have a system and method that takes into account at least some of the issues discussed above, as well as other possible issues.

### BRIEF SUMMARY

Example implementations of the present disclosure are directed to charging cordless power tool batteries. The present disclosure thus includes, without limitation, the following example implementations.

Some example implementations provide a system for charging a plurality of cordless power tool batteries, the system comprising: charging circuitry including: power circuitry configured to convert an alternating current (AC) input power to a direct current (DC) output power; a plurality of electrical connectors connectable to up to j>1 electrical loads; and primary control circuitry configured to direct the DC output power to k≤j of the plurality of electrical connectors that are connected to k≤j electrical loads, separately and in succession; and a plurality of docking stations connectable by electrical wiring to the plurality of electrical connectors as the k≤j electrical loads, each of the plurality of docking stations including: an electrical connector connectable by the electrical wiring to one of the plurality of electrical connectors to receive the DC output power from the charging circuitry; a plurality of charging ports configured to receive up to m>1 of the plurality of cordless power tool batteries; and secondary control circuitry connectable by the electrical wiring to the primary control circuitry to enable communication between the primary control circuitry and the secondary control circuitry, the secondary control circuitry configured to direct the DC output power to recharge n≤m of the plurality of cordless power tool batteries that are received by the plurality of charging ports, separately and in succession under control of the primary control circuitry.

Some example implementations provide a battery charger for charging a plurality of cordless power tool batteries, the battery charger comprising a casing and charging circuitry supported by or housed within the casing, the charging circuitry including: power circuitry configured to convert an alternating current (AC) input power to a direct current (DC) output power; a plurality of electrical connectors connectable by electrical wiring to up to j>1 electrical loads including a plurality of docking stations each of which includes a separate casing configured to support or house secondary control circuitry, and a plurality of charging ports that are configured to receive up to m>1 of the plurality of cordless power tool batteries; and primary control circuitry configured to direct the DC output power to k≤j of the plurality of electrical connectors that are connected to k≤j electrical loads including the plurality of docking stations, separately and in succession, and wherein for each of the plurality of docking stations, the primary control circuitry is configured to control the secondary control circuitry to direct the DC output power to recharge n≤m of the plurality of cordless power tool batteries that are received by the plurality of charging ports, separately and in succession.

Some example implementations provide a docking station for charging a plurality of cordless power tool batteries, the docking station comprising: a casing; and supported by or housed within the casing, secondary control circuitry; a plurality of charging ports configured to receive up to m>1 of the plurality of cordless power tool batteries; and charging circuitry including: power circuitry configured to convert an alternating current (AC) input power to a direct current (DC) output power; a plurality of electrical connectors connectable by electrical wiring to up to j>1 electrical loads including the docking station, and including one or more expansion docking stations each of which includes a separate casing configured to support or house respective secondary control circuitry, and a respective plurality of charging ports that are configured to receive up to m>1 of the plurality of cordless power tool batteries; and primary control circuitry configured to direct the DC output power to k≤j of the plurality of electrical connectors that are connected to k≤j electrical loads including the docking station and one or more expansion docking stations, separately and in succession, and wherein for each of the docking station and the one or more expansion docking stations, the primary control circuitry is configured to control the secondary control circuitry or the respective control circuitry to direct the DC output power to recharge n≤m of the plurality of cordless power tool batteries that are received by the plurality of charging ports or the respective plurality of charging ports, separately and in succession.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a system for charging a plurality of cordless power tool batteries, according to some example implementations of the present disclosure;

FIG. 2 illustrates a system that may correspond to the system shown in FIG. 1, and that includes a battery charger, according to some example implementations;

FIG. 3 illustrates a system that may correspond to the system shown in FIG. 1, and that includes a primary docking station and one or more expansion docking stations, according to some example implementations; and

FIGS. 4 and 5 are flowcharts illustrating various steps in methods of charging a plurality of cordless power tool batteries, according to example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably.

Example implementations of the present disclosure relate generally to charging of rechargeable batteries and, in particular, to charging cordless power tool batteries, such as 40 volt cordless power tool batteries used in cordless power tools of many commercial lawn, garden and landscaping operations. The system generally includes charging circuitry and a plurality of docking stations. The charging circuitry may implement a features a sequential charging architecture with a single 500 watt or 750 watt charging circuitry configured to serially charge multiple cordless power tool batteries one-by-one.

Each of the plurality of docking stations may accommodate a subset of a plurality of cordless power tool batteries. In a particular example, the system may include three docking stations that are each configured to accommodate up to four cordless power tool batteries, thereby providing a total charging capacity of twelve cordless power tool batteries. In various examples, the charging circuitry may be provided by a separate battery charger; and in other examples, the charging circuitry may be integrated with one of the plurality of docking stations (a primary docking station). In one suitable environment, the system may be setup in an enclosed shop or building in which ten or more cordless power tool batteries may be recharged overnight, and then transported to a worksite via a conventional utility trailer.

According to example implementations of the present disclosure, then, ten or more cordless power tool batteries can be charged by one charging circuitry connected to an AC input power supply such as a mains electricity power supply. By only having one charger charging multiple cordless power tool batteries one-by-one may reduce AC power usage needed for recharging, and an end user may better utilize their existing power infrastructure. This may in turn minimize their investment or modifications needed to an existing facility to incorporate the system. As an example, a common USA household 110 volt wall outlet can allow 1500 watts on a normal circuit, and can typically accept two (2) wall plugs per outlet box. An end user could therefore easily plug in two (2) 500 watt systems into an available wall outlet, each recharging ten or more cordless power tool batteries, totaling twenty or more cordless power tool batteries that can be recharged in one charging session. The system may therefore allow the end user to replenish a large array of their daily-use cordless power tool batteries, easily and conveniently in one location of their facility.

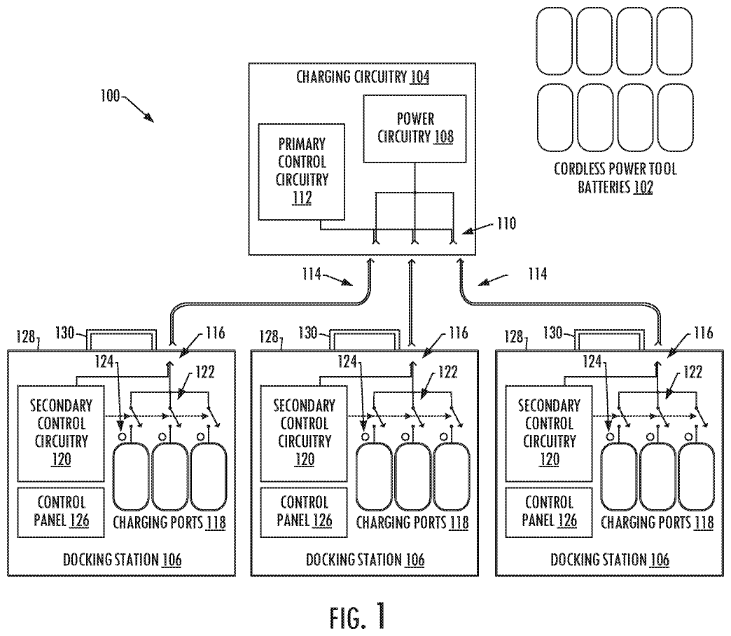

FIG. 1 illustrates a system 100 for charging a plurality of cordless power tool batteries 102, according to some example implementations of the present disclosure. As shown, the system includes charging circuitry 104 and a plurality of docking stations 106. As shown, the charging circuitry includes power circuitry 108 configured to convert an alternating current (AC) input power to a direct current (DC) output power. In various more particular examples, the power circuitry may include power conversion and/or regulation circuitry configured to receive AC mains power (from a mains electricity power supply) as the AC input power, and convert the AC mains power to regulated DC output power. The charging circuitry also includes a plurality of electrical connectors 110 connectable to up to j>1 electrical loads, and primary control circuitry 112 configured to direct the DC output power to k≤j of the plurality of electrical connectors that are connected to k≤j electrical loads, separately and in succession.

In various examples, the charging circuitry 104 may include the plurality of electrical connectors 110 to accommodate up to j docking stations, and the plurality of docking stations include 1<k≤j docking stations. The system 100 shown in FIG. 1 includes three electrical connectors to accommodate up to three docking stations, but it should be understood that the system may include two electrical connectors to accommodate up to two docking stations, or greater than three electrical connectors to accommodate greater than three docking stations (e.g., four docking stations, five docking stations, etc.).

The plurality of docking stations 106 are connectable by electrical wiring 114 to the plurality of electrical connectors as the k≤j electrical loads. Each of the plurality of docking stations includes an electrical connector 116, a plurality of charging ports 118 and secondary control circuitry 120. The electrical connector is connectable by the electrical wiring to one of the plurality of electrical connectors 110 to receive the DC output power from the charging circuitry 104. The plurality of charging ports are configured to receive up to m>1 of the plurality of cordless power tool batteries 102. The secondary control circuitry is connectable by the electrical wiring to the primary control circuitry to enable communication between the primary control circuitry 112 and the secondary control circuitry. In this regard, the secondary control circuitry is configured to direct the DC output power to recharge n≤m of the plurality of cordless power tool batteries that are received by the plurality of charging ports, separately and in succession under control of the primary control circuitry.

In some examples, the secondary control circuitry 120 includes electronic switches 122 controllable by the primary control circuitry 112 to switch the DC output power to recharge n≤m of the plurality of cordless power tool batteries separately and in succession. Examples of suitable electronic switches include relays, transistors (e.g., MOSFETs) or the like.

In some examples, each of the plurality of docking stations 106 further includes a plurality of voltage sensors 124 for the plurality of charging ports 118. In some of these examples, the plurality of voltage sensors are configured to determine a state of charge of the n≤m of the plurality of cordless power tool batteries 102.

In some examples, the primary control circuitry 112 is configured to communicate with the secondary control circuitry 120 to identify a type and determine a state of charge of the n≤m of the plurality of cordless power tool batteries 102. In some of these examples, the primary control circuitry is configured to control the secondary control circuitry to direct the DC output power based on the type and state of charge of the n≤m of the plurality of cordless power tool batteries.

In some examples, the primary control circuitry 112 is configured to control the DC output power to recharge each of the plurality of cordless power tool batteries 102 using at least one of a constant current (CC) charging profile or a constant voltage (CV) charging profile. In some further examples, the primary control circuitry is configured to control the DC output power to recharge the plurality of cordless power tool batteries separately and in succession using the CC charging profile, and then separately and in succession using the CV charging profile. And in yet other examples, the primary control circuitry is configured to control the DC output power to recharge each of the plurality of cordless power tool batteries using a constant current, constant voltage (CCCV) charging profile.

In some examples, each of the plurality of docking stations 106 further includes a control panel 126 configured to display information regarding a state of charge of the n≤m of the plurality of cordless power tool batteries 102, either or both of individually or collectively.

In some examples, each docking station 106 includes a separate casing 128 configured to support or house the electrical connector 116, the plurality of charging ports 118 and the secondary control circuitry 120 of the docking station. This casing may be constructed in a number of different manners, and may be sufficiently robust to withstand the vibration and shock of over-the-road highway transportation; and the casing may be designed to hold the n≤m of the plurality of cordless power tool batteries 102 during transport. In some further examples, the separate casing of the docking station includes either or both of a carry handle 130 or a wall-mounting bracket. A carry handle may improve portability of the docking station, or a wall-mounting bracket may be used to mount the docking station, such as to an interior wall of a utility trailer.

The charging circuitry 104 may be supported or housed in a number of different manners. As explained in greater detail below, in some examples, the system further comprises a battery charger that includes the charging circuitry, and that includes a further separate casing configured to support or house the charging circuitry. In other examples, the plurality of docking stations 106 include a primary docking station and one or more expansion docking stations, and the separate casing of the primary docking station is further configured to support or house the charging circuitry.

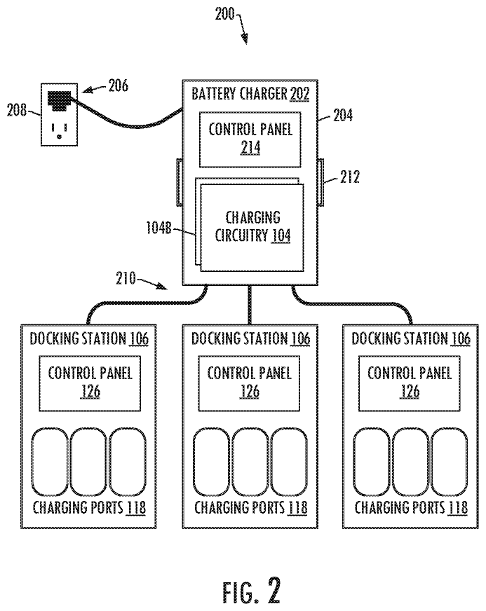

FIG. 2 illustrates a system 200 that in some examples may correspond to the system 100 shown in FIG. 1, and that includes a battery charger 202. As indicated above, the battery charger includes the charging circuitry 104, and a further separate casing 204 configured to support or house the charging circuitry. The system also includes the plurality of docking stations 106, which may be equipped and configured in a manner the same as or similar to that described above with respect to FIG. 1.

As also shown, in some examples, the battery charger 202 further includes an AC power plug 206 configured to connect the battery charger to a socket 208 to which the AC input power is provided from a mains electricity power supply. In some further examples, the battery charger also includes second charging circuitry 104B that includes second power circuitry (similar to power circuitry 108). In some of these examples, the power circuitry and the second power circuitry are configured to receive the AC input power in a parallel configuration.

Referring to FIG. 2 and with further reference to FIG. 1, in some examples, the plurality of electrical connectors 110 of the charging circuitry 104 of the battery charger 202 are connectable to the up to j>1 electrical loads (including the plurality of docking stations 106) by external cables 210 that include the electrical wiring 114. The external cables may therefore bundle the electrical wiring by which the plurality of docking stations are connectable to the plurality of electrical connectors, and by which the secondary control circuitry 120 is connectable to the primary control circuitry 112. These external cables may be detachable (e.g., quick connection) or undetachable from the battery charger. Likewise, the external cables may be detachable or undetachable from the plurality of docking stations.

In some examples, the casing 204 of the battery charger 202 includes either or both of a carry handle or a wall-mounting bracket 212. Additionally or alternatively, in some examples, the battery charger further includes a control panel 214 configured to display information regarding a state of charge of the plurality of cordless power tool batteries 102, either or both of individually or collectively.

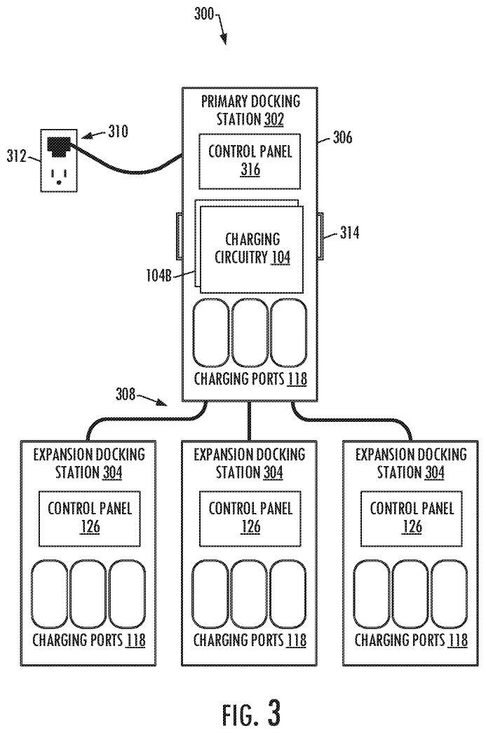

FIG. 3 illustrates a system 300 that in some examples may correspond to the system 100 shown in FIG. 1, and that includes a primary docking station 302 and one or more expansion docking stations 304. As described herein, the primary docking station may at times be more simply referred to as a docking station relative to the one or more expansion docking stations. The one or more expansion docking stations may be generally equipped and configured in a manner the same as or similar to the plurality of docking stations 106 described above with respect to FIG. 1.

Referring to FIG. 3 and with further reference to FIG. 1, the primary docking station 302 may also be similarly equipped and configured as a docking station 106, but it may be further equipped with the charging circuitry 104. In this regard, the primary docking station may include a casing 306 (e.g., separate casing 128) configured to support or house a plurality of charging ports 118 and secondary control circuitry 120, as well as the charging circuitry including power circuitry 108, the plurality of electrical connectors 110 and primary control circuitry 112 (only the plurality of charging ports and charging circuitry separately shown in FIG. 3). The primary docking station may internally include an electrical connector 116 connectable by electrical wiring 114 to one of the plurality of electrical connectors of the charging circuitry to receive the DC output power from the charging circuitry.

The primary docking station 302 may be connectable to each expansion docking station 304 by an external cable 308 that includes the electrical wiring 114. The external cable may therefore bundle the electrical wiring by which the expansion docking station is connectable to one of the plurality of electrical connectors 110 of the charging circuitry 104, and by which the secondary control circuitry 120 of the expansion docking station is connectable to the primary control circuitry 112. As above, the external cable may be detachable or undetachable from either or both of the expansion docking station or the primary docking station.

As the primary docking station 302 is equipped with the charging circuitry 104, in some examples, the primary docking station includes an AC power plug 310 configured to connect the primary docking station to a socket 312 to which the AC input power is provided from a mains electricity power supply. And as above, in some further examples, the primary docking station also includes second charging circuitry 104B that includes second power circuitry (similar to power circuitry 108); and the power circuitry and the second power circuitry are configured to receive the AC input power in a parallel configuration.

In some examples, the casing 306 of the primary docking station 302 includes either or both of a carry handle or a wall-mounting bracket 314. Additionally or alternatively, in some examples, the primary docking station further includes a control panel 316 configured to display information regarding a state of charge of the plurality of cordless power tool batteries 102, either or both of individually or collectively. Additionally or alternatively, as the primary docking station includes its own plurality of charging ports 118, the control panel may be configured to display information regarding a state of charge of the n≤m of the plurality of cordless power tool batteries 102 that are received by the plurality of charging ports, either or both of individually or collectively.

Again turning to FIG. 1, as indicated above, control circuitry including each of the primary control circuitry 112 and secondary control circuitry 120 may include or communicate with various electronic components including electronic switches, sensors and the like. The control circuitry may also include processing circuitry, which is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement aspects of the present disclosure on a single chip or as a single “system on a chip.”

The processing circuitry may be composed of one or more processors alone or in combination with one or more computer-readable storage media. The one or more processors may be embodied as or otherwise include various processing means such as one or more of a microprocessor, coprocessor, controller or other computing or processing device including integrated circuits such as, for example, an ASIC (application specific integrated circuit), an FPGA (field programmable gate array), or the like. In an example implementation, the one or more processors may be configured to execute instructions stored in the one or more computer-readable storage media. In this regard, the computer-readable storage media is generally any piece of computer hardware that is capable of storing information such as, for example, data, computer programs (e.g., computer-readable program code) and/or other suitable information either on a temporary basis and/or a permanent basis. The computer-readable storage media may include volatile and/or non-volatile memory, and may be fixed or removable. The computer-readable storage media is a non-transitory device capable of storing information, and is distinguishable from computer-readable transmission media such as electronic transitory signals capable of carrying information from one location to another.

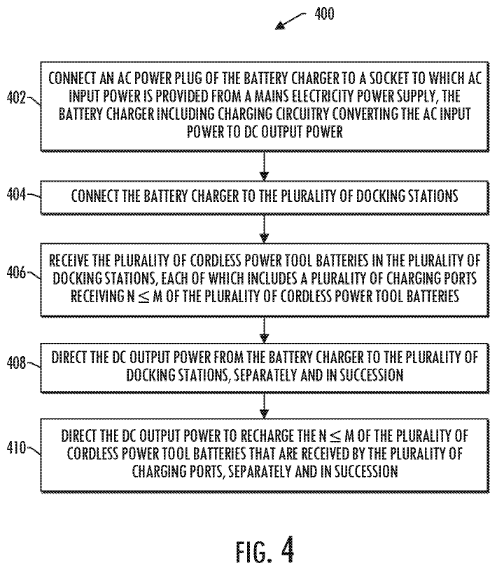

FIG. 4 is a flowchart illustrating various steps in a method 400 of charging a plurality of cordless power tool batteries 102 using a system 200 including a battery charger 202 and a plurality of docking stations 106, according to various example implementations. The method includes connecting an AC power plug 206 of the battery charger to a socket 208 to which AC input power is provided from a mains electricity power supply, the battery charger including charging circuitry 104 converting the AC input power to DC output power, as shown at block 402. The method includes connecting the battery charger to the plurality of docking stations, as shown at block 404. The method includes receiving the plurality of cordless power tool batteries in the plurality of docking stations, each of which includes a plurality of charging ports 118 receiving n≤m of the plurality of cordless power tool batteries, as shown at block 406. The method includes directing the DC output power from the battery charger to the plurality of docking stations, separately and in succession, as shown at block 408. And as the DC output power is directed to each docking station, the method includes directing the DC output power to recharge the n≤m of the plurality of cordless power tool batteries that are received by the plurality of charging ports, separately and in succession, as shown at block 410.

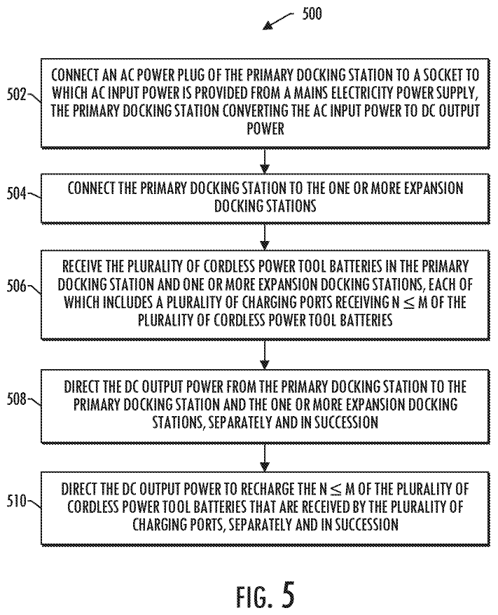

FIG. 5 is a flowchart illustrating various steps in a method 500 of charging a plurality of cordless power tool batteries 102 using a system 300 including a primary docking station 302 and one or more expansion docking stations 304, according to various example implementations. The method includes connecting an AC power plug 310 of the primary docking station to a socket 312 to which AC input power is provided from a mains electricity power supply, the primary docking station converting the AC input power to DC output power, as shown at block 502. The method includes connecting the primary docking station to the one or more expansion docking stations, as shown at block 504. The method includes receiving the plurality of cordless power tool batteries in the primary docking station and one or more expansion docking stations, each of which includes a plurality of charging ports 118 receiving n≤m of the plurality of cordless power tool batteries, as shown at block 506. The method includes directing the DC output power from the primary docking station to the primary docking station and the one or more expansion docking stations, separately and in succession, as shown at block 508. And as the DC output power is directed to each docking station, the method includes directing the DC output power to recharge the n≤m of the plurality of cordless power tool batteries that are received by the plurality of charging ports, separately and in succession, as shown at block 510.

As explained above and reiterated below, the present disclosure includes, without limitation, the following example implementations.

Clause 1. A system for charging a plurality of cordless power tool batteries, the system comprising: charging circuitry including: power circuitry configured to convert an alternating current (AC) input power to a direct current (DC) output power; a plurality of electrical connectors connectable to up to j>1 electrical loads; and primary control circuitry configured to direct the DC output power to k≤j of the plurality of electrical connectors that are connected to k≤j electrical loads, separately and in succession; and a plurality of docking stations connectable by electrical wiring to the plurality of electrical connectors as the k≤j electrical loads, each of the plurality of docking stations including: an electrical connector connectable by the electrical wiring to one of the plurality of electrical connectors to receive the DC output power from the charging circuitry; a plurality of charging ports configured to receive up to m>1 of the plurality of cordless power tool batteries; and secondary control circuitry connectable by the electrical wiring to the primary control circuitry to enable communication between the primary control circuitry and the secondary control circuitry, the secondary control circuitry configured to direct the DC output power to recharge n≤m of the plurality of cordless power tool batteries that are received by the plurality of charging ports, separately and in succession under control of the primary control circuitry.

Clause 2. The system of clause 1, wherein the secondary control circuitry includes electronic switches controllable by the primary control circuitry to switch the DC output power to recharge n≤m of the plurality of cordless power tool batteries separately and in succession.

Clause 3. The system of clause 1 or clause 2, wherein each of the plurality of docking stations further includes a plurality of voltage sensors for the plurality of charging ports, the plurality of voltage sensors configured to determine a state of charge of the n≤m of the plurality of cordless power tool batteries.

Clause 4. The system of any of clauses 1 to 3, wherein the primary control circuitry is configured to communicate with the secondary control circuitry to identify a type and determine a state of charge of the n≤m of the plurality of cordless power tool batteries, and wherein the primary control circuitry is configured to control the secondary control circuitry to direct the DC output power based on the type and state of charge of the n≤m of the plurality of cordless power tool batteries.

Clause 5. The system of any of clauses 1 to 4, wherein the primary control circuitry is configured to control the DC output power to recharge each of the plurality of cordless power tool batteries using at least one of a constant current (CC) charging profile or a constant voltage (CV) charging profile.

Clause 6. The system of clause 5, wherein the primary control circuitry is configured to control the DC output power to recharge the plurality of cordless power tool batteries separately and in succession using the CC charging profile, and then separately and in succession using the CV charging profile.

Clause 7. The system of any of clauses 1 to 6, wherein the primary control circuitry is configured to control the DC output power to recharge each of the plurality of cordless power tool batteries using a constant current, constant voltage (CCCV) charging profile.

Clause 8. The system of any of clauses 1 to 7, wherein each of the plurality of docking stations further includes a control panel configured to display information regarding a state of charge of the n≤m of the plurality of cordless power tool batteries, either or both of individually or collectively.

Clause 9. The system of any of clauses 1 to 8, wherein each docking station includes a separate casing configured to support or house the electrical connector, the plurality of charging ports and the secondary control circuitry of the docking station.

Clause 10. The system of clause 9, wherein the separate casing of the docking station includes either or both of a carry handle or a wall-mounting bracket.

Clause 11. The system of clause 9 or clause 10, wherein the system further comprises a battery charger that includes the charging circuitry, and that includes a further separate casing configured to support or house the charging circuitry.

Clause 12. The system of clause 11, wherein the further separate casing of the battery charger includes either or both of a carry handle or a wall-mounting bracket.

Clause 13. The system of clause 11 or clause 12, wherein the plurality of docking stations are connectable to the plurality of electrical connectors of the battery charger by external cables that include the electrical wiring.

Clause 14. The system of clause 13, wherein the external cables are detachable from either or both of the plurality of docking stations or the battery charger.

Clause 15. The system of clause 13 or clause 14, wherein the external cables are undetachable from either or both of the plurality of docking stations or the battery charger.

Clause 16. The system of any of clauses 11 to 15, wherein the battery charger further includes a control panel configured to display information regarding a state of charge of the plurality of cordless power tool batteries, either or both of individually or collectively.

Clause 17. The system of any of clauses 11 to 16, wherein the battery charger further includes an AC power plug configured to connect the battery charger to a socket to which the AC input power is provided from a mains electricity power supply.

Clause 18. The system of any of clauses 11 to 17, wherein the battery charger further includes second charging circuitry that includes second power circuitry, and wherein the power circuitry and the second power circuitry are configured to receive the AC input power in a parallel configuration.

Clause 19. The system of any of clauses 9 to 18, wherein the plurality of docking stations include a primary docking station and one or more expansion docking stations, and the separate casing of the primary docking station is further configured to support or house the charging circuitry.

Clause 20. The system of clause 19, wherein the primary docking station is connectable to each expansion docking station by an external cable that includes the electrical wiring by which the expansion docking station is connectable to one of the plurality of electrical connectors of the charging circuitry and thereby the primary docking station.

Clause 21. The system of clause 20, wherein the external cable is detachable from either or both of the expansion docking station or the primary docking station.

Clause 22. The system of any of clauses 19 to 21, wherein the primary docking station further includes a control panel configured to display information regarding a state of charge of the plurality of cordless power tool batteries, either or both of individually or collectively.

Clause 23. The system of any of clauses 19 to 22, wherein the primary docking station further includes an AC power plug configured to connect the primary docking station to a socket to which the AC input power is provided from a mains electricity power supply.

Clause 24. The system of any of clauses 19 to 23, wherein the primary docking station further includes second charging circuitry that includes second power circuitry, and wherein the power circuitry and the second power circuitry are configured to receive the AC input power in a parallel configuration.

Clause 25. A battery charger for charging a plurality of cordless power tool batteries, the battery charger comprising a casing and charging circuitry supported by or housed within the casing, the charging circuitry including: power circuitry configured to convert an alternating current (AC) input power to a direct current (DC) output power; a plurality of electrical connectors connectable by electrical wiring to up to j>1 electrical loads including a plurality of docking stations each of which includes a separate casing configured to support or house secondary control circuitry, and a plurality of charging ports that are configured to receive up to m>1 of the plurality of cordless power tool batteries; and primary control circuitry configured to direct the DC output power to k≤j of the plurality of electrical connectors that are connected to k≤j electrical loads including the plurality of docking stations, separately and in succession, and wherein for each of the plurality of docking stations, the primary control circuitry is configured to control the secondary control circuitry to direct the DC output power to recharge n≤m of the plurality of cordless power tool batteries that are received by the plurality of charging ports, separately and in succession.

Clause 26. The battery charger of clause 25, wherein the primary control circuitry is configured to communicate with the secondary control circuitry to identify a type and determine a state of charge of the n≤m of the plurality of cordless power tool batteries, and wherein the primary control circuitry is configured to control the secondary control circuitry to direct the DC output power based on the type and state of charge of the n≤m of the plurality of cordless power tool batteries.

Clause 27. The battery charger of clause 25 or clause 26, wherein the primary control circuitry is configured to control the DC output power to recharge each of the plurality of cordless power tool batteries using at least one of a constant current (CC) charging profile or a constant voltage (CV) charging profile.

Clause 28. The battery charger of clause 27, wherein the primary control circuitry is configured to control the DC output power to recharge the plurality of cordless power tool batteries separately and in succession using the CC charging profile, and then separately and in succession using the CV charging profile.

Clause 29. The battery charger of any of clauses 25 to 28, wherein the primary control circuitry is configured to control the DC output power to recharge each of the plurality of cordless power tool batteries using a constant current, constant voltage (CCCV) charging profile.

Clause 30. The battery charger of any of clauses 25 to 29, wherein the casing of the battery charger includes either or both of a carry handle or a wall-mounting bracket.

Clause 31. The battery charger of any of clauses 25 to 30, wherein the plurality of electrical connectors are connectable to the up to j>1 docking stations by external cables that include the electrical wiring.

Clause 32. The battery charger of clause 31, wherein the external cables are detachable from the battery charger.

Clause 33. The battery charger of clause 31 or clause 32, wherein the external cables are undetachable from the battery charger.

Clause 34. The battery charger of any of clauses 25 to 33, wherein the battery charger further includes a control panel configured to display information regarding a state of charge of the plurality of cordless power tool batteries, either or both of individually or collectively.

Clause 35. The battery charger of any of clauses 25 to 34, wherein the battery charger further includes an AC power plug configured to connect the battery charger to a socket to which the AC input power is provided from a mains electricity power supply.

Clause 36. The battery charger of any of clauses 25 to 35, wherein the battery charger further includes second charging circuitry that includes second power circuitry, and wherein the power circuitry and the second power circuitry are configured to receive the AC input power in a parallel configuration.

Clause 37. A docking station for charging a plurality of cordless power tool batteries, the docking station comprising: a casing; and supported by or housed within the casing, secondary control circuitry; a plurality of charging ports configured to receive up to m>1 of the plurality of cordless power tool batteries; and charging circuitry including: power circuitry configured to convert an alternating current (AC) input power to a direct current (DC) output power; a plurality of electrical connectors connectable by electrical wiring to up to j>1 electrical loads including the docking station, and including one or more expansion docking stations each of which includes a separate casing configured to support or house respective secondary control circuitry, and a respective plurality of charging ports that are configured to receive up to m>1 of the plurality of cordless power tool batteries; and primary control circuitry configured to direct the DC output power to k≤j of the plurality of electrical connectors that are connected to k≤j electrical loads including the docking station and one or more expansion docking stations, separately and in succession, and wherein for each of the docking station and the one or more expansion docking stations, the primary control circuitry is configured to control the secondary control circuitry or the respective control circuitry to direct the DC output power to recharge n≤m of the plurality of cordless power tool batteries that are received by the plurality of charging ports or the respective plurality of charging ports, separately and in succession.

Clause 38. The docking station of clause 37, wherein the secondary control circuitry includes electronic switches controllable by the primary control circuitry to switch the DC output power to recharge n≤m of the plurality of cordless power tool batteries separately and in succession.

Clause 39. The docking station of clause 37 or clause 38, wherein the docking station further comprises a plurality of voltage sensors for the plurality of charging ports, the plurality of voltage sensors configured to determine a state of charge of the n≤m of the plurality of cordless power tool batteries.

Clause 40. The docking station of any of clauses 37 to 39, wherein the primary control circuitry is configured to communicate with the secondary control circuitry to identify a type and determine a state of charge of the n≤m of the plurality of cordless power tool batteries, and wherein the primary control circuitry is configured to control the secondary control circuitry to direct the DC output power based on the type and state of charge of the n≤m of the plurality of cordless power tool batteries.

Clause 41. The docking station of any of clauses 37 to 40, wherein the primary control circuitry is configured to control the DC output power to recharge each of the plurality of cordless power tool batteries using at least one of a constant current (CC) charging profile or a constant voltage (CV) charging profile.

Clause 42. The docking station of clause 41, wherein the primary control circuitry is configured to control the DC output power to recharge the plurality of cordless power tool batteries separately and in succession using the CC charging profile, and then separately and in succession using the CV charging profile.

Clause 43. The docking station of any of clauses 37 to 42, wherein the primary control circuitry is configured to control the DC output power to recharge each of the plurality of cordless power tool batteries using a constant current, constant voltage (CCCV) charging profile.

Clause 44. The docking station of clause 43, wherein the casing includes either or both of a carry handle or a wall-mounting bracket.

Clause 45. The docking station of any of clauses 37 to 44, wherein the docking station is connectable to each expansion docking station by an external cable that includes the electrical wiring by which the expansion docking station is connectable to one of the plurality of electrical connectors of the charging circuitry and thereby the docking station.

Clause 46. The docking station of clause 45, wherein the external cable is detachable from either or both of the expansion docking station or the docking station.

Clause 47. The docking station of any of clauses 37 to 46, wherein the docking station further comprises a control panel configured to display information regarding a state of charge of the plurality of cordless power tool batteries, either or both of individually or collectively.

Clause 48. The docking station of any of clauses 37 to 47, wherein the docking station further comprises a control panel configured to display information regarding a state of charge of the n≤m of the plurality of cordless power tool batteries, either or both of individually or collectively.

Clause 49. The docking station of any of clauses 37 to 48, wherein the docking station further comprises an AC power plug configured to connect the docking station to a socket to which the AC input power is provided from a mains electricity power supply.

Clause 50. The docking station of any of clauses 37 to 49, wherein the docking station further comprises second charging circuitry that includes second power circuitry, and wherein the power circuitry and the second power circuitry are configured to receive the AC input power in a parallel configuration.

Clause 51. A method of charging a plurality of cordless power tool batteries using a system including a battery charger and a plurality of docking stations, the method comprising: connecting an AC power plug of the battery charger to a socket to which AC input power is provided from a mains electricity power supply, the battery charger including charging circuitry converting the AC input power to DC output power; connecting the battery charger to the plurality of docking stations; receiving the plurality of cordless power tool batteries in the plurality of docking stations, each of which includes a plurality of charging ports receiving n≤m of the plurality of cordless power tool batteries; directing the DC output power from the battery charger to the plurality of docking stations, separately and in succession; and as the DC output power is directed to each docking station, directing the DC output power to recharge the n≤m of the plurality of cordless power tool batteries that are received by the plurality of charging ports, separately and in succession.

Clause 52. A method of charging a plurality of cordless power tool batteries using a system including a primary docking station and one or more expansion docking stations, the method comprising: connecting an AC power plug of the primary docking station to a socket to which AC input power is provided from a mains electricity power supply, the primary docking station converting the AC input power to DC output power; connecting the primary docking station to the one or more expansion docking stations; receiving the plurality of cordless power tool batteries in the primary docking station and one or more expansion docking stations, each of which includes a plurality of charging ports receiving n≤m of the plurality of cordless power tool batteries; directing the DC output power from the primary docking station to the primary docking station and the one or more expansion docking stations, separately and in succession; and as the DC output power is directed to each docking station, directing the DC output power to recharge the n≤m of the plurality of cordless power tool batteries that are received by the plurality of charging ports, separately and in succession.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A system for charging a plurality of cordless power tool batteries, the system comprising:
charging circuitry including:
power circuitry configured to convert an alternating current (AC) input power to a direct current (DC) output power;
a plurality of electrical connectors connectable to up to j>1 electrical loads; and
primary control circuitry configured to direct the DC output power to k≤j of the plurality of electrical connectors that are connected to k≤j electrical loads, separately and in succession; and
a plurality of docking stations connectable by electrical wiring to the plurality of electrical connectors as the k≤j electrical loads, each of the plurality of docking stations including:
an electrical connector connectable by the electrical wiring to one of the plurality of electrical connectors to receive the DC output power from the charging circuitry;
a plurality of charging ports configured to receive up to m>1 of the plurality of cordless power tool batteries; and
secondary control circuitry connectable by the electrical wiring to the primary control circuitry to enable communication between the primary control circuitry and the secondary control circuitry, the secondary control circuitry configured to direct the DC output power to recharge n≤m of the plurality of cordless power tool batteries that are received by the plurality of charging ports, separately and in succession under control of the primary control circuitry.

2. The system of claim 1, wherein the primary control circuitry is configured to communicate with the secondary control circuitry to identify a type and determine a state of charge of the n≤m of the plurality of cordless power tool batteries, and
wherein the primary control circuitry is configured to control the secondary control circuitry to direct the DC output power based on the type and state of charge of the n≤m of the plurality of cordless power tool batteries.

3. The system of claim 1, wherein the primary control circuitry is configured to control the DC output power to recharge the plurality of cordless power tool batteries separately and in succession using constant current (CC) charging profile, and then separately and in succession using a constant voltage (CV) charging profile.

4. The system of claim 1, wherein each docking station includes a separate casing configured to support or house the electrical connector, the plurality of charging ports and the secondary control circuitry of the docking station.

5. The system of claim 4, wherein the system further comprises a battery charger that includes the charging circuitry, and that includes a further separate casing configured to support or house the charging circuitry.

6. The system of claim 5, wherein the plurality of docking stations are connectable to the plurality of electrical connectors of the battery charger by external cables that include the electrical wiring, or
wherein the plurality of docking stations include a primary docking station and one or more expansion docking stations, and the separate casing of the primary docking station is further configured to support or house the charging circuitry.

7. The system of claim 5, wherein the battery charger further includes a control panel configured to display information regarding a state of charge of the plurality of cordless power tool batteries, either or both of individually or collectively.

8. The system of claim 5, wherein the battery charger further includes second charging circuitry that includes second power circuitry, and
wherein the power circuitry and the second power circuitry are configured to receive the AC input power in a parallel configuration.

9. (canceled)

10. The system of claim 5, wherein the primary docking station is connectable to each expansion docking station by an external cable that includes the electrical wiring by which the expansion docking station is connectable to one of the plurality of electrical connectors of the charging circuitry and thereby the primary docking station, or
wherein the primary docking station further includes a control panel configured to display information regarding a state of charge of the plurality of cordless power tool batteries, either or both of individually or collectively.

11. (canceled)

12. The system of claim 5, wherein the primary docking station further includes second charging circuitry that includes second power circuitry, and
wherein the power circuitry and the second power circuitry are configured to receive the AC input power in a parallel configuration.

13. A battery charger for charging a plurality of cordless power tool batteries, the battery charger comprising a casing and charging circuitry supported by or housed within the casing, the charging circuitry including:
power circuitry configured to convert an alternating current (AC) input power to a direct current (DC) output power;
a plurality of electrical connectors connectable by electrical wiring to up to j>1 electrical loads including a plurality of docking stations each of which includes a separate casing configured to support or house secondary control circuitry, and a plurality of charging ports that are configured to receive up to m>1 of the plurality of cordless power tool batteries; and
primary control circuitry configured to direct the DC output power to k≤j of the plurality of electrical connectors that are connected to k≤j electrical loads including the plurality of docking stations, separately and in succession, and
wherein for each of the plurality of docking stations, the primary control circuitry is configured to control the secondary control circuitry to direct the DC output power to recharge n≤m of the plurality of cordless power tool batteries that are received by the plurality of charging ports, separately and in succession.

14. The battery charger of claim 13, wherein the primary control circuitry is configured to communicate with the secondary control circuitry to identify a type and determine a state of charge of the n≤m of the plurality of cordless power tool batteries, and
wherein the primary control circuitry is configured to control the secondary control circuitry to direct the DC output power based on the type and state of charge of the n≤m of the plurality of cordless power tool batteries.

15. The battery charger of claim 13, wherein the primary control circuitry is configured to control the DC output power to recharge the plurality of cordless power tool batteries separately and in succession using a constant current (CC) charging profile, and then separately and in succession using a constant voltage (CV) charging profile.

16. The battery charger of claim 13, wherein the battery charger further includes a control panel configured to display information regarding a state of charge of the plurality of cordless power tool batteries, either or both of individually or collectively.

17. The battery charger of claim 13, wherein the battery charger further includes second charging circuitry that includes second power circuitry, and
wherein the power circuitry and the second power circuitry are configured to receive the AC input power in a parallel configuration.

18. A docking station for charging a plurality of cordless power tool batteries, the docking station comprising:
a casing; and supported by or housed within the casing,
secondary control circuitry;
a plurality of charging ports configured to receive up to m>1 of the plurality of cordless power tool batteries; and
charging circuitry including:
power circuitry configured to convert an alternating current (AC) input power to a direct current (DC) output power;
a plurality of electrical connectors connectable by electrical wiring to up to j>1 electrical loads including the docking station, and including one or more expansion docking stations each of which includes a separate casing configured to support or house respective secondary control circuitry, and a respective plurality of charging ports that are configured to receive up to m>1 of the plurality of cordless power tool batteries; and
primary control circuitry configured to direct the DC output power to k≤j of the plurality of electrical connectors that are connected to k≤j electrical loads including the docking station and one or more expansion docking stations, separately and in succession, and
wherein for each of the docking station and the one or more expansion docking stations, the primary control circuitry is configured to control the secondary control circuitry or the respective control circuitry to direct the DC output power to recharge n≤m of the plurality of cordless power tool batteries that are received by the plurality of charging ports or the respective plurality of charging ports, separately and in succession.

19. The docking station of claim 18, wherein the primary control circuitry is configured to communicate with the secondary control circuitry to identify a type and determine a state of charge of the n≤m of the plurality of cordless power tool batteries, and
wherein the primary control circuitry is configured to control the secondary control circuitry to direct the DC output power based on the type and state of charge of the n≤m of the plurality of cordless power tool batteries.

20. The docking station of claim 18, wherein the primary control circuitry is configured to control the DC output power to recharge the plurality of cordless power tool batteries separately and in succession using a constant current (CC) charging profile, and then separately and in succession using a constant voltage (CV) charging profile.

21. The docking station of claim 18, wherein the docking station further comprises a control panel configured to display information regarding a state of charge of the plurality of cordless power tool batteries, either or both of individually or collectively.

22. The docking station of claim 18, wherein the docking station further comprises second charging circuitry that includes second power circuitry, and
wherein the power circuitry and the second power circuitry are configured to receive the AC input power in a parallel configuration.
